(19) United States
(12) Patent Application Publication
(10) Pub. No.: US 2016/0185920 A1
(43) Pub. Date: Jun. 30, 2016

(54) METHODS AND SYSTEMS FOR PROMOTING AND CONTROLLING DEGRADATION OF POLYMERS

(71) Applicant: ASPEN RESEARCH CORPORATION, Maple Grove, MN (US)

(72) Inventor: Roger Pearson, Minneapolis, MN (US)

(21) Appl. No.: 14/910,793

(22) PCT Filed: Aug. 8, 2014
(86) PCT No.: PCT/US2014/050287

§ 371 Date: Feb. 8, 2016

Related U.S. Application Data
(60) Provisional application No. 61/863,651, filed on Aug. 8, 2013.

(51) Int. Cl. C08J 3/20; C08K 5/092; C08K 5/09; C08K 5/00

(52) U.S. Cl. CPC C08J 3/203; C08K 5/0033; C08K 5/092; C08K 5/09; C08J 2367/04; C08J 2367/03

(57) ABSTRACT

Systems and methods for making, engineering and processing of degradation-promoted polymers in accordance with their end-use applications and environmental conditions are provided. The systems and methods include incorporating, blending and compounding the degradation-promoting agent(s) into a polymeric material. The resulting degradation-promoted polymeric material can be molded to create a desired end use product that, when exposed to an application-specific environment, the degradation rate of the degradation-promoted polymer can be enhanced compared to the degradation rate of the input polymer(s) without the incorporated degradation-promoting agents.

### FIELD

This disclosure relates generally to methods and systems for promoting and controlling the degradation of polymers. Particularly, this disclosure relates to methods and systems for promoting and controlling the degradation of polymers during an application life cycle and a post-application life cycle of the polymers.

### BACKGROUND

Petroleum is currently the primary chemical feedstock for the production of polymers. Plastics derived from this commodity are from a non-sustainable source and do not meet the social, political, regulatory and environmental requirements for biodegradability or compostability in landfills.

### SUMMARY

Methods and systems are provided for promoting and controlling the degradation of polymer(s). In particular, methods and systems are provided for promoting and controlling the degradation of polymer(s) during an application life cycle and a post-application life cycle of the polymer(s).

In particular, the methods and systems described herein relate to making and engineering enhanced-degradation polymers and polymeric materials (referred to herein as a “degradation-promoted polymer” or “degradation-promoted polymers”) by incorporating, mixing, processing, blending and/or compounding one or more degradation-promoting agents and other inputs with and into degradable polymers in accordance with desired end-use applications and environmental conditions. When exposed to an application-specific environment, the rate of degradation of the degradation-promoted polymer can be enhanced compared to the degradation of the input degradable polymer(s) without the incorporated agents.

Degradation-promoted polymers may be produced in various forms: for example, they may be produced in intermediate forms, for example pellets or flakes; they may be extruded as end-use products for example gels, coatings, films, threads or adhesives; or they may be extruded through a die or into a mold to produce an end-use article such as a board or other structural member. The intermediate form (pellet, flake or other form) of the degradation-promoted polymer may be utilized by various other methods of molding, forming or processing (e.g., thermoforming, blow-molding, extrusion or injection molding, etc.) to produce end-use products such as, for example, injection molded articles (e.g. plastic cutlery, horticultural pots, etc), films, bottles, or extruded articles. The embodiments described herein allow for the judicious utilization of various inputs and processes for making and engineering degradation-promoted polymers so that the degradation-promoted polymers can degrade in accordance with target application(s) requirements and their given environmental conditions. The inputs can include, for example, degradable polymers, proteins or other polymeric materials, degradation-promoting agents, fillers, modifiers, and other components such as slip agents, UV stabilizers, wetting agents, impact modifiers, etc. These degradation-promoted polymers with promoted degradation properties can be applicable, for example, in aqueous or non-aqueous environments, compost piles, or any environment that is routinely wetted and/or exposed to sunlight and that requires an enhanced, programmable or controlled degradation period.

The embodiments described herein can provide polymers for materials, products and packaging that promote and meet sustainability policies for more environmentally friendly polymers. In addition, the embodiments described herein provide degradability required in a variety of industries. The embodiments described herein provide polymers that meet degradability requirements of industry for end-use application in a specified environment and are desirable. Therefore promoting and controlling the degradation of polymers can be useful and beneficial.

The embodiments described herein allow for the degradation rate of many polymers (referred to herein as “degradable polymers”) to be promoted, enhanced or controlled. For example, many degradable polymers contain ester bonds and when these bonds are broken the material degrades. Degradable polymers can include, for example, polylactic acid (PLA), polyhydroxyalkanoic acid (PHA) polymers including, for example, Polyhydroxybutyrate (PHB), poly glycolic acid (PGA), etc., and other polyesters including such as, for example, polybutylene succinic acid (PBS), etc. Some degradable polymers can be generated through bio-transformation of organic feedstock (such as corn) and others can be petroleum based, and yet others can be combinations of both.

Naturally-occurring fillers such as, for example, organic fibers, and some inorganic fillers such as, for example, calcium carbonate and calcium sulfate (both of which can be biodegradable), may be compounded into degradable polymers such as, for example, PHAs and/or other polyesters to improve mechanical or thermal properties of the degradable polymer or the degradation-promoted polymer.

The embodiments described herein further relate to making, engineering, processing, and/or compounding of degradation-promoted polymers in accordance with their end-use application requirements and environmental conditions. More specifically the embodiments described herein relate to the blending and compounding of degradable polymer(s) with degradation-promoting agent(s) that are designed to promote degradation of the resulting degradation-promoted polymers in accordance with end-use application requirements and environmental conditions. Furthermore, this disclosure relates to promoting and controlling the degradation of degradation-promoted polymers by utilizing degradable polymers that may be modified. It is to be understood that both the degradable polymers and the resulting degradation-promoted polymers may be blends of polymers, blends of polymers and proteins, hybrid materials comprising bonded polymers and non-polymeric materials, and/or composites of any of the foregoing.

In some embodiments, the degradable polymers may be modified, for example, by blending and/or combining them with other polymers, fillers or additives, for purposes of meeting processing needs and the physical and/or degradation requirements of the intended application or applicable environmental conditions. Furthermore, the embodiments described herein incorporate the use of fillers that may or may not be modified or compatibilized. Such fillers may be inorganic (for example, calcium carbonate, glass, etc.) or organic fillers (for example, wood, flax, hemp, avian feathers and other organic materials).

In one embodiment, a degradation-promoted polymer material may be engineered to be utilized in an environment having a temperature above, for example, about 22° C. and a moist environment, such as, for example, horticultural pots, where the degradation of the degradation-promoted polymer can commence at its first use and be accelerated when planted into the ground with the plant.

In another embodiment, a degradation-promoted polymer material may be engineered to act as a pressure-bearing moisture barrier material that is required to degrade, for example, about 90% in an aqueous or acidic brine fluid at a temperature of, for example, about 60° C. within, for example, about 21 days where degradation begins at first contact with the environment.

In another embodiment, a degradation-promoted polymer material may be engineered to diminish bio-fouling of metals by coating the degradation-promoted polymer thereon. The degradation-promoted polymer can also be used for other applications, for example as a protective coating or film that degrades in a shorter time frame in an aqueous or moist environment than a non-degradation-promoted polymer.

The methods and systems described herein can allow for engineering a degradation-promoted polymer by incorporating, processing, compounding or blending one or more types and amounts of inputs (including, for example, degradable polymers, degradation-promoting agents, other polymers or polymeric materials, fillers and/or additives that can influence the degradation rate) that can be chosen to achieve the required or desired physical, chemical or other properties of the degradation-promoted polymer and can meet the environmental, degradation and other requirements or conditions of the application.

Furthermore, the compounding of a degradable polymer with a degradation-promoting agent may be accomplished by the utilization of a continuous compounding/extrusion process such as, for example, a twin screw compounder extruder.

Furthermore, for continuous process compounding a degradable polymer with a degradation-promoting agent, the appropriate manner, sequence, steps and control of the compounding can be managed to achieve, among other things, an even distribution and disbursement of the degradation-promoting agent without breaking down the degradation-promoting agent. An intimate contact of the degradation-promoting agent throughout the polymeric structure of the degradable polymer can be achieved for better control of the degradation. This intimate contact between the degradable polymer and the degradation-promoting agent can promote the rate of degradation of the resulting degradation-promoted polymer. For example, the energy of activation required for degradation, for example, hydrolysis of a polymer containing ester bonds, can be reduced.

In one embodiment a degradable polymer is compounded with the appropriate amount and type of degradation-promoting agent, for example, an acidic moiety, to obtain a degradation-promoted polymer.

In some embodiments, a degradable polymer to which the degradation-promoting agent can be added can include, for example, PHA polymers, including, for example, polylactic acid (PLA) and polyglycolic acid (PGA).

In some embodiments, a degradable polymer to which the degradation-promoting agent can be added can include, for example, other degradable ester polymers such as, for example, polybutylene succinate and polycaprolactone.

In one embodiment, a degradation-promoting agent can be compounded with a blend of two or more degradable polymers such as, for example, PHA polymers that have been blended for specific physical properties. The blends can include, for example, a polylactic acid and polyglycolic acid blend, a polylactic acid and polyhydroxybutyrate blend, blends of polylactic acid polymers having differing base polymer properties, etc.

In one embodiment, a degradation-promoting agent can be compounded into a blend of at least one degradable polymer and at least one non-degradable polymer such that upon completion of the degradation process the matrix of the non-degradable polymer can remain intact.

In one embodiment, a degradation-promoting agent may be an acidic moiety incorporated into a degradable polymer such as, for example, polymers including ester bonds such as, for example, a PHA or ester polymer, which acidic moiety can promote the rate of degradation through, for example, hydrolysis by an acid-catalyzed attack of an ester bond of the degradable polymer in environmental conditions where there is direct contact with water, or under moist conditions, and temperature ranges, for example, from about 22° C. to about 160° C.

In one embodiment, a non-degradable polymeric film can be sandwiched with a protective coating of a degradation-promoted polymer such that when the sandwiched material comes in contact with water the coating degrades, leaving an internal film exposed. The protective coating may coat, for example, both sides of a cation-exchange membrane (CEM) that can be used in electrolytic-activated water generators. The utility of such a degradation-promoted material can allow for the assembly of an electrolysis device and the CEM material without removal of the protective films/coatings prior to assembly, which otherwise may require the removal of the protective film at the time of assembly and maintaining the CEM in an aqueous environment to maintain its integrity.

In one embodiment, a degradation-promoting agent for promoting degradation of degradable polymers such as, for example, PHAs, and other degradable ester polymers, may include low molecular weight organic acids. The low molecular weight organic acids can include, for example, formic acid, acetic acid, oxalic acid, succinic acid, etc.

In one embodiment, a degradation-promoting agent for promoting degradation of degradable polymers may include Lewis acids such as, for example, Cu²⁺, Zn²⁺, Mg²⁺, etc., delivered as common salts, for example, sulfates (copper sulfate) or chlorides (zinc chloride).

In one embodiment, a degradation-promoting agent for promoting degradation of degradable ester polymers may include Lewis acids delivered as an organometallic material such as, for example, titanium tetrabutoxide, etc.

In one embodiment, a degradable polymer and a degradation-promoting agent such as, for example, an acidic moiety for degradation promotion can be compounded where the acidic moiety added may be for example from about 5 percent to about 25 percent the weight of the degradation-promoted polymer.

In one embodiment, a degradation-promoting agent may be a UV enhancer such as, for example, titanium oxide anatase, etc. A degradable polymer may be a vinyl such as, for example, polyvinyl chloride, where degradation can be promoted in the presence of ultraviolet (UV) radiation.

In one embodiment, a UV degradation-promoting agent such as, for example, zinc oxide, may be blended with a degradable polymer including an olefin such as, for example, polypropylene. In an acidic environment, the degradable polymer can degrade by oxidation as a result of photo catalysis.

In one embodiment, a UV degradation-promoting agent may be added to another degradation-promoting agent such as, for example, an acidic moiety.

In one embodiment, a degradation-promoting agent may be a peroxide and a degradable polymer can include an olefin such as, for example, polypropylene, where degradation can be promoted as a result of oxidation.

In one embodiment of a compounding process, a degradation-promoting agent is blended with a degradable polymer. Any residual water can be evacuated or de-volatized. The resulting degradation-promoted polymer can be extruded by, for example, an extruder.

In one embodiment of a compounding process, an acidic degradation promoter is blended with degradable polymer such as, for example, a PHA or other ester polymer. Any residual water can be evacuated or de-volatized. The resulting degradation-promoted polymer can be extruded by, for example, an extruder.

In one embodiment, a compounded and extruded degradation-promoted polymer may be in an intermediate form of a pellet or flake for use in other molding or forming processes that may include, for example, thermoforming, injection molding, extrusion, etc., for the production of an end-use product such as, for example, molded articles, films and bottles.

In one embodiment, a compounded degradation-promoted polymer may be extruded, for example, through a die to produce a resulting end-use product in the form of, for example, a structural member.

In one embodiment, a compounded degradation-promoted polymer may be extruded as end-use products that are gels or liquids such as adhesives and coatings.

In one embodiment of a compounding process, a degradable polymer can be modified by saponification such as, for example, through the addition of a caustic. The modified polymer can be de-volatized. The de-volatized polymer can be blended with a degradation-promoting agent such as, for example, an acid moiety. The blended mixture can be evacuated to remove any residual water, prior to extrusion and pelletization. The PHA polymer may be, for example, polylactic acid (PLA), which may include PLAs of more than one molecular weight. The PLAs can be saponified/modified to achieve a different average molecular weight by addition of a caustic such as, for example, sodium hydroxide. The saponified/modified PLAs can be de-volatized. The de-volatized PLAs can be blended with a degradation-promoting agent. The acid moiety can be an organic acid such as, for example, succinic acid. The acid moiety can also be a Lewis acid such as, for example, copper sulfate. The blended mixture of the PLAs and the acid moiety can then be extruded through a die and pelletized.

In one embodiment, a degradation-promoted polymer or a degradation-promoted modified polymer as described above may be compounded with one or more inorganic or organic fillers where the fillers may further be compatibilized, to produce a composite thereof.

In one embodiment, fillers may be inorganic materials such as, for example, calcium carbonate, TiO₂, glass, etc.

In one embodiment, fillers may be organic in nature such as, for example, avian feathers, fibers (e.g., hemp, wood, flax, other bio-based fibers, etc.), etc. that may provide desired physical characteristics while providing cost savings, and assisting in degradation of the degradation-promoted polymer as a result in the reduction of the degradation promoted polymer's mass.

In one embodiment, fillers compounded with a degradation-promoted polymer may be, for example, about 5 percent to about 65 percent the weight of the degradation-promoted polymer. The degradation-promoting agent may be, for example, about 5 percent to about 25 percent the weight of the degradation-promoted polymer.

In one embodiment, fillers may be about 5 percent to about 80 percent by weight of the degradation-promoted polymer. A degradation-promoting agent may be, for example, about 2 percent to about 50 percent of the weight of the degradation-promoted polymer. A master batch, which is a material that is a concentrate that may be diluted in a secondary process, can be produced and then let down (diluted) at least 2 times by weight of the master batch in the secondary process with the same or other polymer(s).

In one embodiment, organic fillers may be compatibilized and compounded with degradable polymer and degradation-promoting agent. An organic filler and a compatibilizer can be input to a compounder for compounding. The compatibilized filler can be evacuated and devolatized to remove moisture and volatiles. Then a degradable polymer and a degradation-promoting agent can be input and compounded with the compatibilized filler. The resulting material can be further evacuated and devolatilized as needed to remove moisture and volatiles, and to produce a degradation-promoted compatibilized composite polymer.

In one embodiment, a compatibilization process can include the addition of a maleic acid to a filler such as, for example, wood fibers, to create a compatibilized wood. Any unused maleic acid and water can then be evacuated. The compatibilized filler can be compounded with a degradable polymer and a degradation-promoting agent that are to be blended together, and then evacuated to remove any residual water.

In one embodiment of a compounding process, a degradable polymer such as, for example, a PHA polymer can be modified by saponification such as, for example, by addition of a caustic. The modified polymer can be de-volatized. A degradation promoting agent such as, for example, an acidic moiety, can be blended with the modified polymer. A filler that may already be compatibilized can be fed and blended into the blended, modified degradable polymer.

In one embodiment, other additives may be blended or compounded with a degradable polymer or a composite thereof at an appropriate time during the process. Additives may include, for example, impact modifiers, UV stabilizers, UV enhancers, anti-oxidants, plasticizers, wetting agents, etc.

In one embodiment, additives may be blended or compounded with a degradable polymer, or a composite thereof such that, upon degradation, an acid or other material can be released to provide a further effect on the degradation-promoted polymer or its environment, such as the degradation, dissolution or transformation of materials surrounding or in contact with the degradation-promoted polymer.

In one embodiment, a degradation-promoted polymer, a blended degradation-promoted polymer, or a composite thereof, may be subjected to an environment that contains water or an acidic brine solution, and carbonate salts where the degradation of the degradation-promoted polymer occurs through hydrolysis, releasing an acid of sufficient strength to neutralize and thus promote dissolution of the carbonate salts. This can be particularly useful in the oil and gas industry. For example, an engineered pressure bearing moisture barrier degradation-promoted polymer may be required that can degrade about 90% in an aqueous or acidic brine fluid at a temperature of about 60° C. within 21 days or 100° C. within about 21 days. Degradation can begin at first contact with environment. Upon degradation of a degradation-promoted polymer a resulting acid will be released that will neutralize and promote the dissolution of the carbonate salt (mud cake) that is utilized in the drilling of oil wells.

### BRIEF DESCRIPTION OF DRAWINGS

FIG. 1 illustrates a system for producing degradation-promoted polymers according to one embodiment.

FIG. 2 illustrates a process diagram for producing a degradation-promoted polymer, according to one embodiment.

FIG. 3 illustrates a process diagram for producing a degradation-promoted polymer blend, according to one embodiment.

FIG. 4 illustrates a process diagram for producing a degradation-promoted modified polymer, according to one embodiment.

FIG. 5 illustrates a process diagram for producing a degradation-promoted polymer composite, according to one embodiment.

FIG. 6 illustrates a process diagram for producing a degradation-promoted polymer composite utilizing a compatibilized filler, according to one embodiment.

FIG. 7 illustrates a process diagram for producing a degradation-promoted modified polymer composite, according to one embodiment.

FIG. 8 illustrates a process diagram for producing a degradation-promoted polymer based on a petroleum based polymer, according to one embodiment.

FIG. 9a illustrates the degradation of a PHA polymer as a function of time, according to one embodiment.

FIG. 9b illustrates the degradation of a PHA polymer as a function of time under different water temperature, according to one embodiment.

FIG. 9c illustrates the change in pH over time for two different molecular weight PLAs added with a degradation-promoting agent, according to one embodiment.

### DETAILED DESCRIPTION

In the following detailed description, reference is made to the accompanying drawings and experimental data, which form a part hereof, and in which are shown, by way of illustration, specific embodiments in which the methods and systems described herein may be practiced. These embodiments are described in sufficient detail to enable those skilled in the art to practice the described systems and methods, and it is to be understood that the embodiments may be combined or used separately, or that other embodiments may be used, and that design, implementation, and procedural changes may be made without departing from the spirit and scope of the methods and systems described herein. The following detailed description provides examples and data resulting from experiments performed.

The methods and systems described herein are provided for promoting and controlling the degradation of a degradable polymer during an application life cycle and a post-application life cycle of the polymer.

Embodiments are also provided for engineering a degradation-promoted polymer by the judicious choice of types and amounts of inputs (e.g., specific degradable polymers, degradation promoters, fillers and/or other additives) that can influence the degradation rate without degrading the physical or other properties of the resulting material and that meet the environmental, degradation and other requirements or conditions of the application. Furthermore, the appropriate manner, sequence, steps and control of the compounding process of the degradable polymer with the degradation-promoting agent can be managed to achieve, among other things, an even distribution and disbursement of the degradation-promoting agent without breaking it down, resulting in its intimate contact throughout the polymeric structure for better control of the polymer degradation. This intimate contact between the polymer and the degradation-promoting agent promotes the rate of degradation by reducing the energy of activation required for degradation, by example the hydrolysis of a polymer containing ester bonds.

The term “input” or “inputs” as used herein is defined as any input material, chemical, compound or substance that is an additive or component utilized to produce a degradation-promoted polymer. The inputs may include at least one degradable polymer and a degradation-promoting agent, as well as one or more modifiers (e.g., a caustic moiety), fillers, filler compatibilizers, modifiers, impact modifiers, wetting and slip agents, UV enhancers, etc.

The term “polymer” as used herein is defined as any macromolecule or system of macromolecules commonly referred to as “polymeric,” and includes without limitation naturally-occurring and synthetically-produced macromolecules, repeating and non-repeating chain macromolecules, plant and animal proteins and degradable polymer(s).

The term “polymeric material” as used herein is defined as one or more polymer(s) or other materials comprising or containing polymer(s), including without limitation blends of polymers, co-polymers, hybrid materials comprising bonded polymers and non-polymeric materials, and/or composites of or including any of the foregoing. The term “polymeric material” may also include a degradable polymer or a degradation-promoted polymer.

The term “degradable polymer” as used herein is defined as one or more polymers or polymeric materials in which degradation can be accelerated by adding one or more degradation-promoting agents. The degradable polymer can include, for example, ester based polymers such as, for example PHA's and/or olefins such as, for example, polypropylene.

The term “degradation-promoted polymer” used herein refers to a resulting material (which can include one or more polymers or polymeric materials) that has been engineered by the compounding processing of degradable polymers through the methods and systems described herein, in accordance with desired end-use applications and environmental conditions.

The terms “engineer” or “engineering” as used herein refer to the making of degradation-promoted polymer(s) through the judicious choice of inputs (such as degradable polymers, degradation-promoting agents, fillers, modifiers, and/or other additives or components), and processing parameters and methods (including manner, sequence, steps and controls) to achieve physical and degradation characteristics of the degradation-promoted polymer in accordance with application requirements and environmental conditions.

The terms “degradation-promoting agent” and “promoting agent” and may be used interchangeably and refer to a moiety that is blended with an input polymer including a degradable polymer, a polymer blend and/or composite material such that, when the resulting material is subjected to appropriate environmental conditions the degradation-promoting agent can accelerate the degradation of the resulting material (as compared to the degradation rate of the input polymer material without the degradation-promoting agent) at a rate required for the specific application and environmental conditions.

In one embodiment, when using an acidic moiety such as, for example, succinic acid, as the degradation-promoting agent a degradation-promoting mechanism of the input polymer can include an initial attack of hydrogen ion on a carbonyl followed by a subsequent proton transfer cleavage of the ester bond and liberation of the alcohol and acid in a water rich environment. For example, degradation can proceed through ester hydrolysis. Examples of acid moieties that can act as degradation-promoting agents can include, for example, low molecular weight organic acids such as, for example, formic, acetic, adipic, oxalic, succinic, and/or Lewis acids such as for example Cu²⁺, Zn²⁺, Mg²⁺, etc., delivered as common salts such as, for example, sulfates and chlorides or as organocomplexes of the metallic ions such as, for example, titanium tetrabutoxide.

The terms “degradation-promoted polymer” and “promoted polymer” that are interchangeably used herein are defined as a degradable polymer that has been blended with a degradation-promoting agent for purpose of controlling and accelerating the degradation of the polymer in accordance with its application requirements and environmental conditions.

The terms “compound”, “blend”, “mix,” “combine,” “process” and “incorporate,” as well as their variants and synonyms, may be used interchangeably and as used herein are defined as a process, that may be continuous and that may utilize a compound/extrusion machine, for the homogeneous blending and mixing together of various inputs of at least one polymer with additives, such as degradation-promoting agents, modifiers, compatibilizers, fillers, plasticizers, stabilizers, and pigments; that following the compounding of material the process may extrude an intermediate form of the material such as pellet or flake that will be utilized in another process as by example injection molding or thermoforming to produce an end-use article, may extrude an end-use article, (by example an adhesive, coating, or gel) or may extrude the material through a die to produce an end-use article such as a structural member.

The term “polyhydroxyalkanoic acid” refers to a class of polymers that is herein represented by the acronym PHA and is used interchangeably within this disclosure. Polylactic acid and polyglycolic acid are examples of PHAs. Additional examples of PHAs include polyhydroxybutyrate, polyhydroxyvalerate and polyhydroxyhexanoate and their copolymers, such as, for example, poly(lactic-co-glycolic acid), poly(hydroxybutyrate-co-hydroxyvalerate), etc. PHAs have the general structure of:

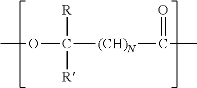

where n is greater than or equal to zero and where R or R′ can be either hydrogen or alkyl groups such as methyl, ethyl, etc.

The term “ester polymers” as used herein is defined as polymers that contain an ester linkage in the backbone of the polymer. Ester polymers include, for example, PHAs such as PLA, PGA, etc., polycaprolactone (PCL), polyethyleneterphthalate (PET) and polymers formed by the copolymerization of a diol and a diacid, such as, for example, polybutylene succinate, polyethylene adipate, etc.

The term “caustic” as used herein refers to basic moieties that include, for example, hydroxides (such as, for example, sodium hydroxide, potassium hydroxide, etc.) or carbonates (such as calcium carbonate, sodium carbonate, bicarbonate, etc.) that are used to modify a bio-based polymer (for example, PLA) by base saponification.

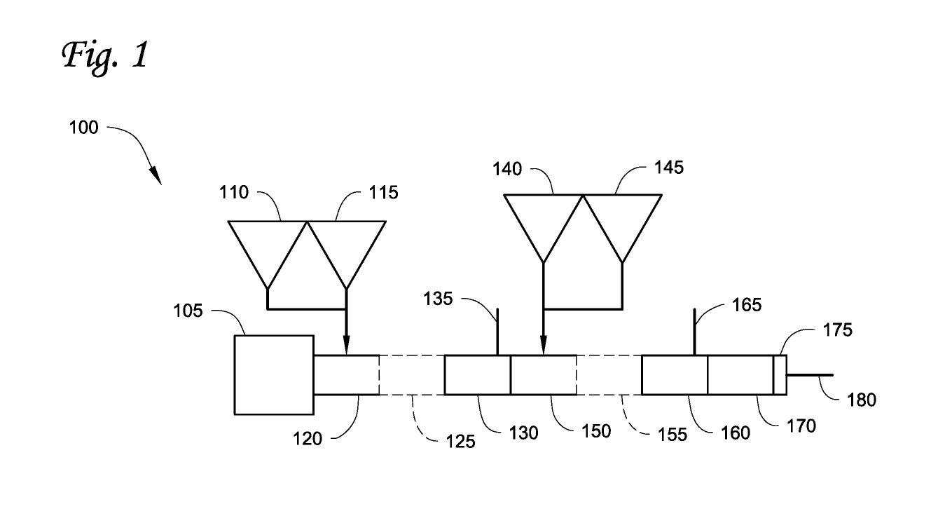

FIG. 1 illustrates a block diagram of a compounding and extrusion system 100 for producing degradation-promoted polymers in a desired form such as, for example, pellets, flakes, powders, liquids, gels, or any other form that can be utilized as an end-use product, or extruded from a die or otherwise further processed to produce an end-use product. A twin screw compounder/extruder 105 having multiple barrels 120, 125, 130, 150, 155, 160 and 170 for multiple inline processes can be applied in a sequence or concurrently. Multiple feeds 110, 115, 140, 145, that are based upon the number of feed components required to produce the resultant extrudate material 180 are provided. In one embodiment, PHA polymers and/or other degradable ester polymers, and a degradation-promoting agent are blended on the twin screw compounder/extruder 105 which includes feeds 110, 115 for feeding inputs or components (e.g., polymers and/or degradation-promoting agent) to the first barrel 120 and where compounding may continue through at least one of barrels 125 for a dwell time that insures the blending and generates maximum intimate contact between the polymer and degradation-promoting agent. The dwell time can be dependent upon the degradable polymer, the degradation-promoting agent, and/or a temperature profile that the inputs need to insure an intimate contact and distribution. Water and/or volatiles within the blended mixture can be removed by, for example, the venting barrel 130 including a venting mechanism 135 that can pull a vacuum. Then the blended material enters the barrel 170 that can move the blended material through a die 175 to form the extrudate 180 where upon the extrudate may be pelletized by a variety of commonly available means. In one embodiment, PHA polymer, for example, polylactic acid (PLA), and degradation-promoting acid, for example, succinic acid, are input 110, 115 to the barrel 120 where blending is initiated.

Referring to FIG. 1, the system 100 may optionally incorporate a polymer modification component to modify the degradable polymer prior to blending with a degradation-promoting agent to reduce the molecular weight of the polymer. In one embodiment, a polymer such as, for example, PLA, and a caustic such as, for example, sodium hydroxide can be inputs 110, 115 into the barrel 120 to modify the PLA polymer. Additional barrels 125 can be used for blending the PLA polymer and the caustic for a predetermined dwell time to achieve a desired molecular weight of the PLA polymer. A working temperature can be in a range of 175° C. to 230° C. depending upon the inputs being utilized. The dwell time can be dependent on the volume per hour and can vary based upon parameters of a compounder/extruder to run the process and the molecular weight to be achieved. Any remaining caustic within the modified PLA polymer can be de-volatized and evacuated at the barrel 130 through the mechanism 135. The modified PLA is input to the barrel 150 directly from the barrel 130 where the acidic or basic degradation-promoting agent can be input 140 and blended in at least a first barrel 150 and a plurality of barrels 155 for appropriate dwell time of process to insure the blending generates maximum intimate contact between the polymer and degradation-promoting agent. The blended material is input to the barrel 160 including a venting means 165 that can pull a vacuum, to remove any resulting water and volatiles. Then the blended modified material enters the barrel 170 that can push the blended modified material through a die 175 to form the extrudate 180. The extrudate 180 can be processed to form a product having a suitable form. For example, the extrudate 180 can be pelletized.

Referencing again to FIG. 1, the system 100 may optionally compatibilize a filler prior to blending of a degradable polymer such as, for example, PHA or other ester polymer, and a degradation-promoting agent. In one embodiment, in the system 100, a filler that may be organic or inorganic, and a compatibilizing component are input as the feeds 110, 115 into the barrel 120 and may utilize a plurality of barrels 125 for a predetermined dwell time to compatibilize the material. Any resulting water and volatiles within the compatibilized filler can be removed by the venting mechanism 135 at the barrel 130 that can pull a vacuum. The venting barrel 130 inputs the compatibilized filler into the blending barrel 150 where the degradable polymer (e.g., PHA or other ester polymer) and the degradation-promoting agent are input 140, 145. The polymer and degradation-promoting agent are blended together and further compounded with the compatibilized filler in at least the barrel 150 and the optional barrels 155 for a predetermined dwell time to insure the blending generates a maximum intimate contact between the polymer and degradation-promoting agent and even distribution of compatibilized filler throughout blended polymer. Any resulting water and volatiles within the blended materials can be removed by the venting means 165 in the barrel 160 that can pull a vacuum. The blended materials then move through a die 175 to form the extrudate 180 that may be pelletized. The filler can be an organic filler such as, for example, wood fiber or flour. The compatibilizing agent for compatibilizing the filler includes, for example, maleic acid.

In another embodiment, the production of a degradation-promoted PHA or other ester polymers may include a first polymer modification step to reduce the molecular weight followed by a blending step of the modified polymer with the degradation-promoting agent and a parallel process of inputting an uncompatibilized filler or compatibilized filler input through the side port to be blended with the modified polymer and degradation-promoting agent. It would be known to those familiar with the art that a single barrel compounder or multi-barrel compounder that may pre-process a feed material that may input to the primary process at any required side port to enhance the inputs to a primary compounder/extruder.

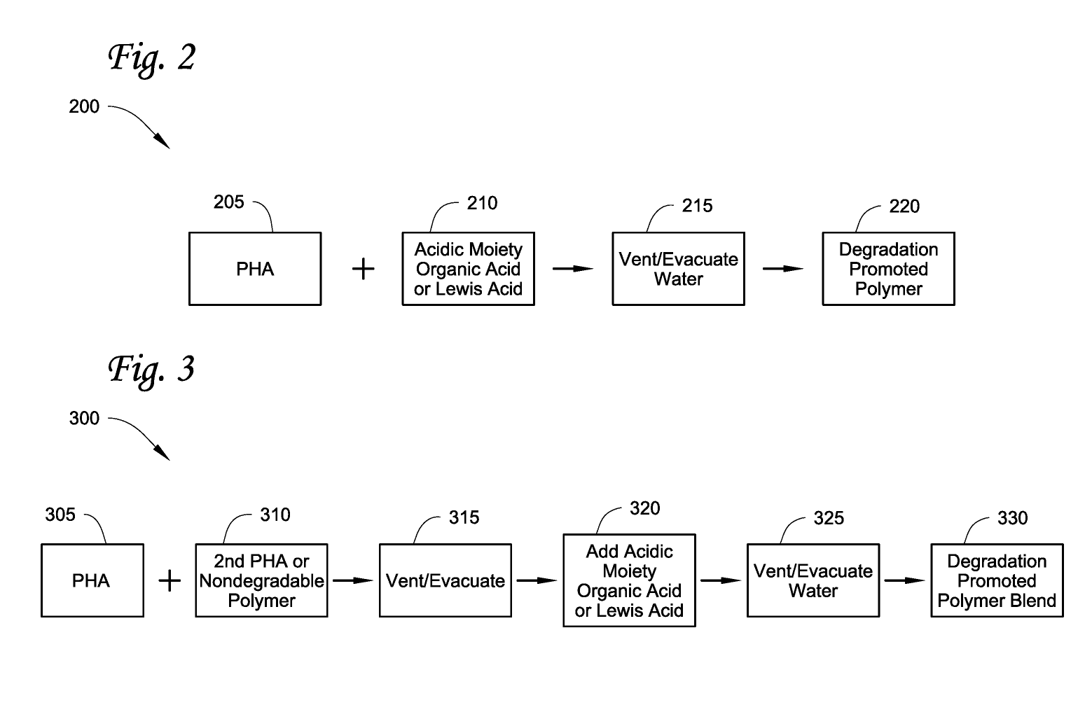

FIGS. 2 through 8 illustrate different process flowcharts of compounding degradation-promoted polymers in various useful forms. It is to be understood that the steps in the flowcharts can be modified, moved, removed, replaced with additional steps and otherwise customized based on the type of degradation-promoted polymer to be generated. Furthermore it is to be understood that achieving melt flow temperatures of the polymers may vary by the type of polymer and control of shear and temperature can be exercised when blending the degradation-promoting agent as they may have lower melt temperatures than that of the polymer which may require the cooling of the polymer previous to addition of the degradation-promoting agent so as to prevent it from reaching its boiling temperature decomposing in some manner. Other components may be added as appropriate such as for example pigment, plasticizer, impact modifiers, etc. at appropriate times throughout the process. It would be appreciated that the extrudate material may be pelletized for future use in molding processes by example only, injection molding, thermoforming, or other extrusion process or extruded into a part through a die to form the part.

FIG. 2 illustrates a flow chart 200 for compounding a degradation-promoted polymer. At block 205, a degradable polymer such as, for example, a PHA or other ester polymer is added as an input into a first barrel such as, for example, the barrels 120, 125, 130, 150, 155, 160 and 170 of FIG. 1. At block 210, a degradation-promoting agent such as, for example, an acid moiety is added as a second input into the barrel and blended with the degradable polymer. The acid moiety can include an organic acid and/or Lewis acid. The degradation-promoting agent can be brought to a melt flow temperature and blended with the degradable polymer in the first barrel to produce the degradation-promoted polymer. Optional subsequent barrels may be used for uniform disbursement and distribution of the degradation-promoting agent into the degradable polymer. At block 215, any residual water within the degradation-promoted polymer can be vented and/or evacuated out of the degradation-promoted polymer. At block 220, the degradation-promoted polymer is extruded, for example, through a die, to form a predetermined shape.

In another embodiment, for compounding the degradation-promoted polymer, at the block 205, the input of the degradable polymer can be brought to a melt flow temperature in the first barrel, followed by venting and evacuation of water.

At block 210, the degradation-promoting agent can be further blended in the first barrel and/or subsequent barrels as required for uniform disbursement and distribution of the degradation-promoting agent into the degradable polymer.

At the block 215, any residual water within the compounded degradation-promoted polymer can be vented and/or evacuated out of the degradation-promoted polymer.

At the block 220, the degradation-promoted polymer is extruded, for example, through a die.

FIG. 3 illustrates a flow chart 300 for compounding a degradation-promoted polymer blend. At block 305, one or more degradable polymers such as, for example, PHA and/or other degradable ester polymer are added into a first barrel.

At block 310, a second polymer that may include a PHA, other degradable ester polymer, and/or a non-degradable polymer such as polypropylene, is added into the first barrel and blended with the degradable polymer. Such blends of polymers can have improved physical properties and/or improved degradability, and can include a blend of, for example, PLA and PGA, or, PLA and PBH, or PLA and protein. The crystallinity of the PLA in these blends can be improved and the degradability of the blended polymer(s) can also be improved. The blended degradable polymers and second polymer can be input to subsequent barrels for further blending.

At block 315, the blended polymer(s) is vented and evacuated to remove any residual water off-gassing or other fluids as a result of blending the two polymers.

At block 320, a degradation-promoting agent such as, for example, an acid moiety, is input in a following barrel and blended in the required subsequent barrels with the blended polymer(s) to achieve a uniform disbursement and distribution of the degradation-promoting agent within the blended polymer(s) and the degradation-promoted polymer blend can be produced.

At block 325, the degradation-promoted polymer blend is vented and evacuated to remove, for example, residual water. At block 330, the degradation-promoted polymer blend is extruded to form a predetermined shape.

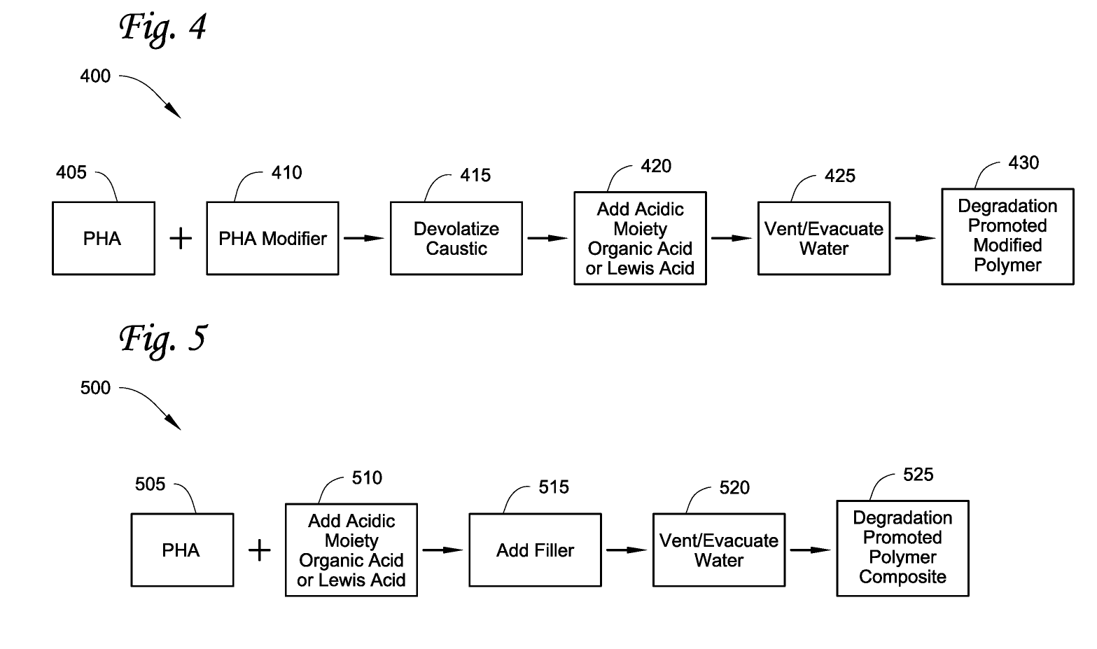

FIG. 4 illustrates a flow chart 400 for compounding a degradation-promoted modified polymer. At block 405, a degradable polymer such as, for example, PHA or other degradable ester polymer is added into a first barrel.

At block 410, a PHA modifier is added into the first barrel to blend with and modify the degradable polymer. One or more subsequent barrels can be used for the blending. The PHA modifier may be a basic moiety (e.g., caustic) that acts upon the degradable polymer to decrease its molecular weight by, for example, saponification. The degradable polymer may be, for example, a recycled PLA that may include PLAs of various molecular weights and that can be modified for purposes of obtaining a more consistent molecular weight, which further provides better control of degradation promotion of the degradable polymer. An example of a caustic modifier for PLA can be sodium hydroxide. The number of barrels as required for predetermined dwell time to achieve the modification required is dependent on, for example, the degradable polymer to be modified, and/or the caustic to be used and the desired molecular weight to be achieved.

At block 415, the modified degradable polymer is de-volatized to neutralize the caustic therein.

At block 420, the modified polymer is blended with a degradation-promoting agent such as, for example, an acid moiety to achieve a uniform disbursement and distribution of the acidic moiety and to produce the degradation-promoted modified polymer.

At block 425, the degradation-promoted modified polymer is vented and evacuated to remove, for example, residual water.

At block 430, the degradation-promoted modified polymer is extruded to form a predetermined shape.

FIG. 5 illustrates a process flowchart 500 for compounding a degradation-promoted composite polymer. At block 505, a degradable polymer such as, for example, a PHA polymer or other degradable ester polymer, is added into a first barrel.

At block 510, a degradation-promoting agent such as, for example, an acid moiety that may include an organic acid and/or a Lewis acid, is blended with the degradable polymer. At the block 510, the degradation-promoting agent can be brought to a melt flow temperature and blended in the first barrel and/or subsequent barrels as required for uniform disbursement and distribution of the degradation-promoting agent into the degradable polymer.

At block 515, the blended material is further blended with an organic or inorganic filler for even distribution of the filler and to produce a degradation-promoted composite polymer. The filler can be pre-modified.

At block 520, the degradation-promoted composite polymer is vented and evacuated to remove any resulting water.

At block 525, degradation-promoted composite polymer is extruded to form a predetermined shape.

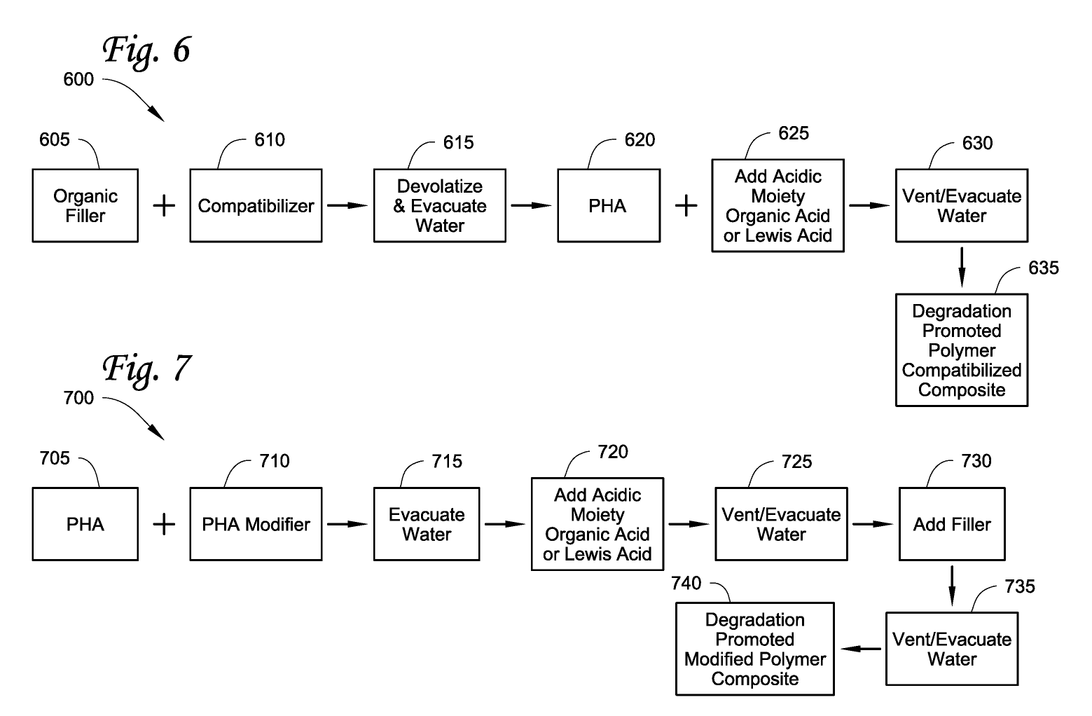

FIG. 6 illustrates a process flowchart 600 for compounding a degradation-promoted compatibilized composite polymer. At block 605, a filler is input to a first barrel.

At block 610, a compatibilizer is input to the first barrel to compatibilize the filler. The filler can be compatibilized in one or more required subsequent barrels.

At block 615, the compatibilized filler is de-volatized and evacuated to remove, for example, residual water. The filler may be organic in nature such as, for example, a wood or flax fiber. The compatibilizer may be, for example, maleic acid (e.g., anhydride).

At block 620, the modified filler is input to a subsequent barrel where a degradable polymer such as, for example, PHA or other degradable ester polymer, is input brought to a melt flow point by addition of temperature and shear, and blended with the modified chiller.

At block 625, a degradation-promoting agent such as, for example, an acid moiety, which may occur in the first barrel or a following barrel, is blended with the degradable polymer to achieve even disbursement and distribution of the compatibilized filler and the degradation-promoting agent throughout the degradable polymer 620, and to produce the degradation-promoted compatibilized composite polymer.

At block 630, the degradation-promoted compatibilized composite polymer followed is vented and evacuated to remove, for example, residual water.

At block 635, the degradation-promoted compatibilized composite polymer is extruded to form a predetermined shape.

FIG. 7 illustrates a process flowchart 700 for compounding a degradation-promoted modified polymer composite. At block 705, a degradable polymer such as, for example, a PHA or other degradable ester polymer is input to a first barrel.

At block 710, a modifier such as, for example, a PHA modifier is input to the first barrel or subsequent barrels to blend with degradable polymer. The PHA modifier may be a basic moiety (e.g., caustic) that acts upon the degradable polymer to decrease its molecular weight by, for example, saponification.

At block 715, the modified degradable polymer is de-volatized to neutralize the caustic therein.

At block 720, the modified degradable polymer is blended with a degradation-promoting agent such as, for example, an acid moiety to achieve a uniform a disbursement and distribution of the degradation-promoting agent within the modified degradable polymer, and to produce the degradation-promoted modified polymer composite.

At block 725, the degradation-promoted modified polymer composite is vented and evacuated to remove, e.g., residual water.

At block 730, the degradation-promoted modified polymer composite is blended with a filler. The filler may not or may be compatibilized prior to the blending.

At block 735, the degradation-promoted modified polymer composite is vented and evacuated to remove any residual water.

At block 740, the degradation-promoted modified polymer composite is extruded to form a predetermined shape.

It is to be understood that processes illustrated in the processes 300 through 700 may be applied to petroleum based polymers such as, for example, polypropylene, blends and/or composites, and their required degradation-promoting agent(s) without deviating from the spirit of the embodiments described herein.

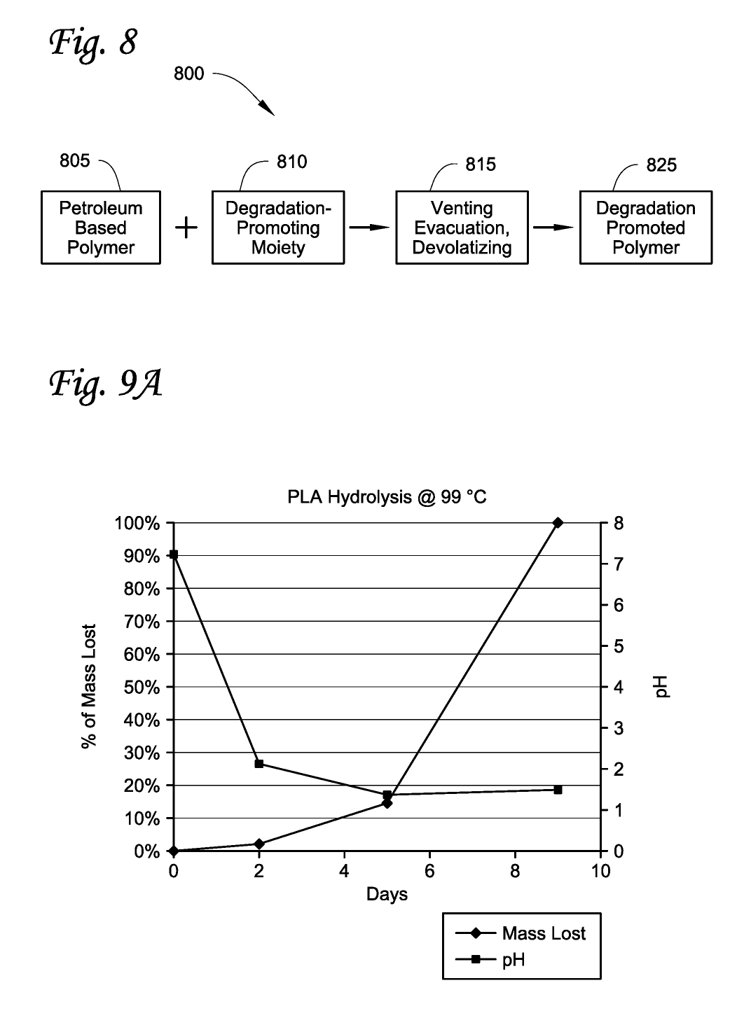

FIG. 8 illustrates a process flowchart 800 of producing a degradation-promoted polymer based on a petroleum based polymer. At block 805, the petroleum based polymer such as, for example, vinyls, olefins, etc., is input into a first barrel.

At block 810, a degradation-promoting agent as a second input that may be a metal oxide, for example, titanium oxide anatase, zinc oxide, a peroxide, etc., can be blended with the petroleum based polymer. The inputs can be brought to a melt flow temperature and blended in the first barrel and/or subsequent barrels as required for uniform disbursement and distribution of the degradation-promoting agent into the petroleum based polymer to produce a degradation-promoted polymer.

At block 815, the blended material is vented, evacuated or de-volatized as required to remove, for example, residual water.

At block 820, the blended material is extruded, for example, through a die to form the degradation-promoted polymer in a predetermined shape.

In another embodiment, at the block 805, the input of the petroleum based polymer can be brought to a melt flow temperature in the first barrel. The petroleum based polymer can be vented, evacuated and/or de-volatized required.

At the block 810, the degradation-promoting agent as a second input as the second input at a following barrel can be further blended in subsequent barrels as required for uniform disbursement and distribution of the degradation-promoting agent into the petroleum based polymer, and to produce a degradation-promoted polymer.

At the block 815, the blended material is vented evacuated and/or de-volatized as required.

At the block 820, the blended material is extruded, for example, through a die to form the degradation-promoted polymer in a predetermined shape. The embodiments shown in FIGS. 1-7 by illustration are described as a single inline sequential process performed on a compounder/extruder. However it is appreciated that the embodiments provided herein may be practiced to produce a degradation-promoted polymer using one or more independent processes and/or parallel processes.

Experiments for investigating polymer degradation rates are conducted by placing a known amount (for example, about 5 gm) of polymer, or polymer blends, into a vessel containing the test fluid (for example, about 50 ml) which can include water or acidic brine, capping the vessel and holding at a predetermined temperature are now described. The polymer or the polymer blends can be blended with a degradation promoter. Periodically, the amount of polymeric weight, e.g. solids remaining at a given time point can be determined by filtering the solids, blotting the solids dry, removing the solids from filter paper and then weighing the solids (i.e. the polymer wet weight as measured). The weight percentage remaining is an expression of wet polymer weight at a Time (t) divided by the initial dry polymer weight. At each time interval after measuring the solids weight, the solids can be placed back into the original test fluids, its container and the experiment can be continued at the predetermined temperature.

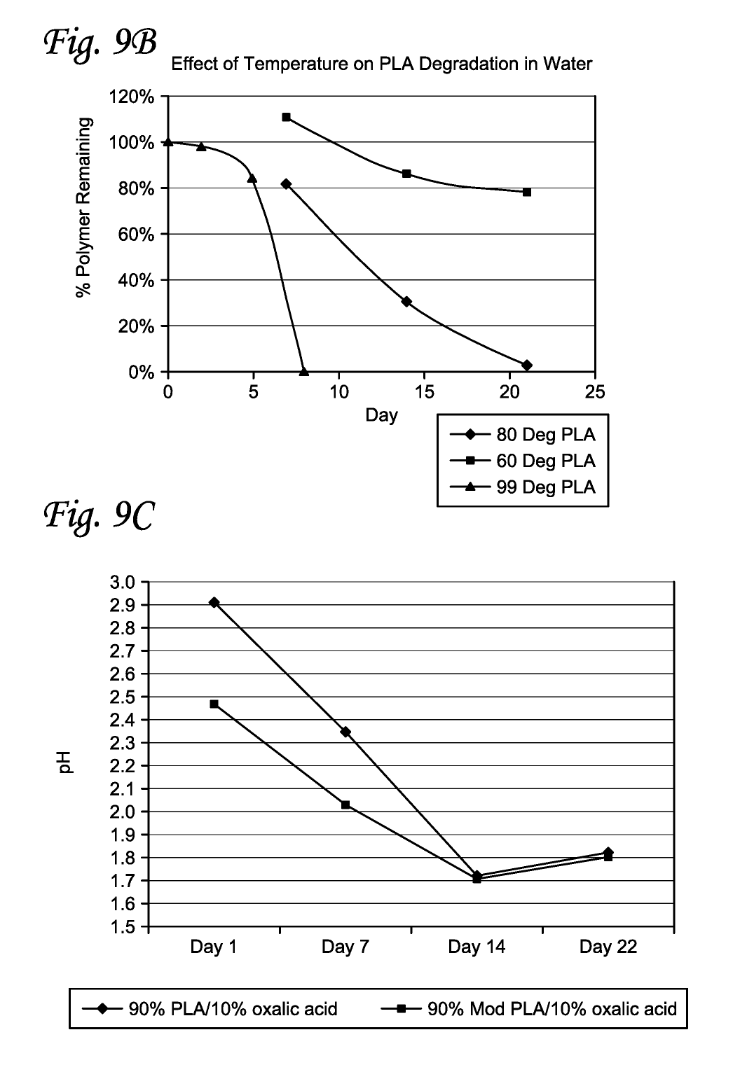

FIG. 9a illustrates the polymeric mass loss (degradation) of a PHA polymer (4060D PLA) at 99° C. with subsequent acid generation with resultant decrease in pH. The decrease in mass and pH over time can be a result of the degradation process (hydrolysis in this instance) due to a proton transfer cleavage of the ester bond and liberation of the alcohol and acid via water addition.

FIG. 9b illustrates the effect of an environmental change (e.g., water temperature) on the rate of degradation of a PHA polymer (e.g., 4060 PLA) without a degradation promoter. The effects shown in FIG. 9b can act as a control for further experiments described below and can teach degradation behavior of PLA at different temperatures. FIG. 9b further reflects that the rate of water absorption at about 60° C. is greater than the rate of hydrolysis at about 60° C. during the first 10 days. This phenomenon is further supported in Tables 1-6. However, at about 99° C. and about 80° C. the rate of hydrolysis is not greater than the rate of water absorption.

FIG. 9c illustrates the change in pH over time with the addition of 10% oxalic acid as the degradation-promoting agent to two different molecular weight PLAs, a PLA and a modified PLA. The modified PLA can be a PLA that is modified by saponification, for example, through the addition of a caustic. The study was carried out in water at 60° C. The decrease in pH is consistent with hydrolysis of the PLA to yield lactic acid. The lactic acid released is capable of dissolving basic salts such as calcium carbonate, magnesium sulfate, and calcium sulfate.

The addition of oxalic acid increases the rate of hydrolysis which subsequently liberates the acid (in this case lactic acid) which in turn can be used to neutralize basic salts or dissolve a non-aqueous-based mud such as calcium carbonate. Table 1 illustrates the increase in rate of degradation of two different molecular weight PLAs blended with an oxalic acid. 4060D PLA is a PLA with a specific product designation for a grade of the PLA and MOD 4060D PLA is a modified 4060D PLA where the 4060D PLA is saponified by compounding 4060D PLA with sodium hydroxide to reduce its molecular weight. After 8 days, both the 4060D PLA and the MOD 4060D PLA without oxalic acid gained weight. That is, the rate of water uptake outstrips the hydrolysis rate. Further note that the rate of weight loss is greater when the oxalic acid is added.

TABLE 1
Effects of 10% Oxalic Acid over time on sample materials
screened in Water (at 60° C.)

| Sample Material | |
|---|---|
| 4060D | MOD |
| PLA | 4060D PLA |

| Duration (days) | 8 | 13 | 7 | 14 |
|---|---|---|---|---|
| Without Oxalic A. | 111% | 86 | 111 | 67 |
| With 10% Oxalic A. | 101% | 74 | 93 | 63 |

Table 2 and Table 3 illustrate that the addition of acidic moieties blended into ester polymers can increase the rate of degradation (for example, hydrolysis) relative to polymers that have not been blended with a degradation-promoting acid moiety. mPBS is a commercially available modified polybutyl succinate from BioAmber. In Table 2 after about 8 days, all polymers without succinic acid gained weight relative to time zero. That is, the rate of water uptake outstrips the hydrolysis rate). Further note that the rate of weight loss is greater when a succinic acid is added. In Table 3 the acidic moiety is copper sulfate (CuSO₄). The 4060D PLA/PGA is a 50:50 blend of Kuredex poly glycolic acid and the 4060D PLA.

TABLE 2
Effects of 10% Succinic Acid over time on sample
materials screened in Water (at 60° C.)

| | Sample Material | | | | | |
|---|---|---|---|---|---|---|
| | | | MOD | | | |
| | 4060D | | 4060D | | | |
| | PLA | | PLA | | mPBS | |
| | Duration (days) | | | | | |
| | 8 | 13 | 7 | 14 | 7 | 14 |
| Without Succinic | 111 | 86 | 111 | 67 | 127 | 125 |
| Acid | | | | | | |
| With 10% | 83 | 65 | 91 | 54 | 100 | 97 |
| Succinic Acid | | | | | | |

TABLE 3
Effects of 5% Copper Sulfate over time on
sample materials screened in Water

| Sample Material | | |
|---|---|---|
| | MOD | 4060D |
| 4060D | 4060D | PLA/ |
| PLA | PLA | PGA |

Duration (days)

| | 8 | 13 | 7 | 14 | 7 | 14 |
|---|---|---|---|---|---|---|
| Without | 111 | 86 | 111 | 67 | 127 | 125 |
| CuSO₄ | | | | | | |
| With 5% | 106 | 72 | 104 | 64 | 112 | 108 |
| CuSO₄ | | | | | | |

Table 4, 5 and 6 present data where the environment is acidic brine at about 60° C. It should be noted that, in the duration row, measurements were taken at different time point designators “x/y” (e.g., 11/7, 18/14) where x is the duration at which the “without CuSO₄” measurement was made and “y” is the duration at which the “with CuSO₄” measurement was taken. Table 4 shows that in the case of the PHAs the acidic brine environment does not increase the rate of hydrolysis over that which occurs in water at 60° C. compared to Table 2 (row labeled “Without”) but the addition of the degradation-promoting acid moiety still increases the degradation rates. In the case of other polyesters (for example, PBS) the rate of hydrolysis is unchanged from that in water (Table 5 compared to Table 2); however the Perstorp PCL (a commercially available polycaprolactone) hydrolysis rate is increased in the acidic brine environment relative to water (PCL did not degrade in water in the duration).

TABLE 4
Effects of 10% Oxalic Acid over time on sample materials
screened in acidic brine (at 60° C.)

| Sample Material | |
|---|---|
| 4060D | MOD |
| PLA | 4060D PLA |

| Duration (days) | 11/7 | 18/14 | 7 | 14 |
|---|---|---|---|---|
| Without Oxalic | 119 | 90 | 106 | 66 |
| With 10% Oxalic | 100 | 62 | 87 | 69 |
| acid | | | | |

TABLE 5
Effects of 10% Succinic Acid over time on
sample materials screened in acidic brine
(at 60° C.)

| | Sample Material | | | | | | | |
|---|---|---|---|---|---|---|---|---|
| | | | MOD | | | | | |
| | 4060D | | 4060D | | Perstorp | | | |
| | PLA | | PLA | | PCL | | mPBS | |
| | Duration (days) | | | | | | | |
| | 11/7 | 18/14 | 7 | 14 | 11/7 | 18/14 | 7 | 14 |
| Without Suc.A | 119 | 90 | 106 | 66 | 115 | 100 | 136 | 116 |
| With 10% Suc.A | 84 | 61 | 87 | 52 | 85 | 82 | 98 | 94 |

TABLE 6
Effects of 5% Copper Sulfate over time on
sample materials screened in acidic brine
(at 60° C.)

| | Sample Material | | | | | | | |
|---|---|---|---|---|---|---|---|---|
| | | | MOD | | | | 4060D | |
| | 4060D | | 4060D | | Perstorp | | PLA/ | |
| | PLA | | PLA | | PCL | | PGA | |
| | Duration (days) | | | | | | | |
| | 11/7 | 18/14 | 7 | 14 | 11/7 | 18/14 | 7 | 14 |
| Without | 119 | 90 | 106 | 66 | 115 | 100 | 107 | 99 |
| CuSO₄ | | | | | | | | |
| With 5% | 114 | 77 | 102 | 62 | 110 | 71 | 121 | 99 |
| CuSO₄ | | | | | | | | |

Table 6 shows that copper sulfate has the similar degradation effects as succinic acid (Table 5).

### Aspects:

It is noted that any of aspects 1-18 can be combined.
Aspect 1. A method for promoting the degradation of a polymer, comprising:

compounding a degradable polymer and a degradation promoting agent to produce a degradation-promoted polymer

wherein the polymer includes PHA polymers, and a degradation promoting agent includes an acidic moiety including an organic acid or a Lewis acid.
Aspect 2. The method of aspect 1, wherein the organic acid includes oxalic acid, adipic acid, succinic acid, lactic acid, and citric acid.
Aspect 3. The method of any of aspects 1-2, wherein the Lewis acid includes Cu²⁺, Zn²⁺, Mg²⁺ delivered as salts.
Aspect 4. The method of any of aspects 1-3, wherein the polymer includes vinyl polymers.
Aspect 5. The method of any of aspects 1-4, wherein the polymer includes polyester polymers.
Aspect 6. The method of any of aspects 1-5, comprising:

blending two or more polymers; and

compounding the blend of the polymers and the degradation promoting agent.
Aspect 7. The method of aspect 6, wherein the polymers include at least one degradable polymer and at least one non-degradable polymer.
Aspect 8. A method for promoting the degradation of a polymer, comprising:

compounding a petroleum based polymer and a degradation promoting agent to produce a degradation-promoted polymer,

wherein the petroleum polymer includes a vinyl and/or an olefin.
Aspect 9. The method of aspect 8, wherein the degradation promoting agent includes a UV enhancer.
Aspect 10. The method of aspect 9, wherein the UV enhancer includes at least one of titanium oxide anatase, and zinc oxide, the vinyl includes a polyvinyl chloride, and the olefin includes a polypropylene.
Aspect 11. The method of any of aspects 8-10, wherein the degradation promoting agent includes a UV enhancer and an acidic moiety.
Aspect 12. The method of any of aspects 8-11, the degradation promoting agent includes a peroxide.
Aspect 13. The method of any of aspects 8-12, further comprising extruding the degradation-promoted polymer to form a predetermined shape.
Aspect 14. A method for promoting the degradation of a polymer, comprising:

blending a degradable polymer with a modifier to modify the degradable polymer;

de-volatizing the modified polymer;

blending the degradation promoting agent with the modified polymer to produce a degradation-promoted polymer; and

extruding the degradation-promoted polymer to a predetermined form.
Aspect 15. The method of aspect 14, comprising modifying the degradable polymer by saponification.
Aspect 16. The method of any of aspects 14-15, further comprising:

blending a compatibilized filler with the degradation-promoted polymer to produce a degradation-promoted polymer composite;

venting and evacuating the degradation-promoted polymer composite to remove residual water;

blending the degradation-promoted polymer composite with a second filler; and

extruding the degradation-promoted polymer composite to form a predetermined shape.
Aspect 17. A method for promoting the degradation of a degradable polymer, comprising:

blending a degradable polymer with a degradation promoting agent to produce a degradation-promoted polymer;

blending a filler with the degradation-promoted polymer to produce a degradation-promoted composite polymer;

evacuating the degradation-promoted composite polymer to remove residual water; and

extruding the degradation-promoted composite polymer to form a predetermined shape.
Aspect 18. The method of aspect 17, further comprising:

compatibilizing the filler;

devolatizing and evacuating the compatibilized filler;

blending the compatibilized filler with the degradation-promoted polymer to produce a degradation-promoted compatibilized composite polymer;

evacuating the degradation-promoted compatibilized composite polymer to remove residual water; and

extruding the degradation-promoted compatibilized composite polymer to form a predetermined shape.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What claimed is:

1. A method for promoting the degradation of a polymer, comprising:
compounding a degradable polymer and a degradation promoting agent to produce a degradation-promoted polymer
wherein the polymer includes PHA polymers, and a degradation promoting agent includes an acidic moiety including an organic acid or a Lewis acid.

2. The method of claim 1, wherein the organic acid includes oxalic acid, adipic acid, succinic acid, lactic acid, and citric acid.

3. The method of claim 1, wherein the Lewis acid includes Cu²⁺, Zn²⁺, Mg²⁺ delivered as salts.

4. The method of claim 1, wherein the polymer includes vinyl polymers.

5. The method of claim 1, wherein the polymer includes polyester polymers.

6. The method of claim 1, comprising:
blending two or more polymers; and
compounding the blend of the polymers and the degradation promoting agent.

7. The method of claim 6, wherein the polymers include at least one degradable polymer and at least one non-degradable polymer.

8. A method for promoting the degradation of a polymer, comprising:
compounding a petroleum based polymer and a degradation promoting agent to produce a degradation-promoted polymer,
wherein the petroleum polymer includes a vinyl and/or an olefin.

9. The method of claim 8, wherein the degradation promoting agent includes a UV enhancer.

10. The method of claim 9, wherein the UV enhancer includes at least one of titanium oxide anatase, and zinc oxide, the vinyl includes a polyvinyl chloride, and the olefin includes a polypropylene.

11. The method of claim 8, wherein the degradation promoting agent includes a UV enhancer and an acidic moiety.

12. The method of claim 8, the degradation promoting agent includes a peroxide.

13. The method of claim 8, further comprising extruding the degradation-promoted polymer to form a predetermined shape.

14. A method for promoting the degradation of a polymer, comprising:
blending a degradable polymer with a modifier to modify the degradable polymer;
de-volatizing the modified polymer;
blending the degradation promoting agent with the modified polymer to produce a degradation-promoted polymer; and
extruding the degradation-promoted polymer to a predetermined form.

15. The method of claim 14, comprising modifying the degradable polymer by saponification.

16. The method of claim 14, further comprising:
blending a compatibilized filler with the degradation-promoted polymer to produce a degradation-promoted polymer composite;
venting and evacuating the degradation-promoted polymer composite to remove residual water;
blending the degradation-promoted polymer composite with a second filler; and
extruding the degradation-promoted polymer composite to form a predetermined shape.

17. A method for promoting the degradation of a degradable polymer, comprising:
blending a degradable polymer with a degradation promoting agent to produce a degradation-promoted polymer;
blending a filler with the degradation-promoted polymer to produce a degradation-promoted composite polymer;
evacuating the degradation-promoted composite polymer to remove residual water; and
extruding the degradation-promoted composite polymer to form a predetermined shape.

18. The method of claim 17, further comprising:
compatibilizing the filler;
devolatizing and evacuating the compatibilized filler;
blending the compatibilized filler with the degradation-promoted polymer to produce a degradation-promoted compatibilized composite polymer;
evacuating the degradation-promoted compatibilized composite polymer to remove residual water; and
extruding the degradation-promoted compatibilized composite polymer to form a predetermined shape.
